(19) United States
(12) Patent Application Publication
(10) Pub. No.: US 2014/0105099 A1
(43) Pub. Date: Apr. 17, 2014

(54) SYSTEM FOR SYNCHRONIZING A SATELLITE POINTING DEVICE

(71) Applicant: THALES, Neuilly-sur-Seine (FR)

(72) Inventor: Marc TOURET, Gennevilliers (FR)

(21) Appl. No.: 14/052,609

(22) Filed: Oct. 11, 2013

(30) Foreign Application Priority Data
Oct. 12, 2012 (FR) 12 02728

(51) Int. Cl. H04B 7/14; H04L 7/00

(52) U.S. Cl. CPC H04B 7/14; H04L 7/00
USPC 370/315

(57) ABSTRACT

A system for synchronizing a satellite pointing device using the transmission of a satellite synchronization signal in a set of contiguous time intervals, comprises first means of selection of at least two time intervals belonging to the set. The system also comprises second means of selection of at least two distinct transmission frequencies, each transmission frequency being associated with one of the said selected time intervals. Finally the system comprises means for modulating the synchronization signal in the selected time intervals by using the transmission frequency respectively associated with the time interval and means for demodulating the synchronization signal received.

### CROSS-REFERENCE TO RELATED APPLICATION

This application claims priority to foreign French patent application No. FR 1202728, filed on Oct. 12, 2012, the disclosure of which is incorporated by reference in its entirety.

### FIELD OF THE INVENTION

The present invention relates to a method allowing the synchronization in respect of a pointing device of a satellite terminal with a satellite or a terrestrial station. All of these elements belonging to one and the same satellite transmission system.

### BACKGROUND

Methods of satellite pointing using the transmission of a synchronization signal based on a modulated pseudo random sequence are known in the state of the art. This modulation can for example be carried out by using a phase modulation with two states (known also within the state in the art by the name BPSK for Binary Phase Shift Keying). This synchronization signal is also known in the state of the art by the name beacon.

However, in the case where a source of interference is present, this interference risks degrading the synchronization performance with a synchronization signal known by the name of beacon signal or beacon in the state of the art. It is also known to use the expression “acquisition of the beacon” to designate this process. It is then no longer possible for a satellite terminal or a ground station to correctly point its antenna towards the satellite and therefore the satellite terminal or the ground station can no longer exchange information with the other satellite terminals or ground stations. To limit the influence of such interference, it is known to increase the synchronization signal or beacon signal transmission power. However, this increase in transmission power is not always compatible with the power available in the satellite or in the terrestrial station. Moreover this increase in power may be prohibited by legislation.

Moreover, in the case of the use of electronic-scanning antennas the angle of pointing of the antenna depends inter alia on the frequency used (transmission or reception). Thus, if the scanning antenna is pointed at an angle A to receive a signal at a frequency F1 (synchronization signal or beacon signal), the simultaneous reception of a signal at the frequency F2 (useful signal) involves an off-boresight angle differing from A. The angular discrepancy in reception being proportional to the off-boresight angle and to the relative discrepancy in frequency, the level received on F2 will be all the weaker the more the two frequencies F1 and F2 differ and the higher the off-boresight angle. For example, in the Ka band the off-boresight angle can be greater than 1°, thus involving a loss of link budget of greater than 0.2 dB.

### SUMMARY OF THE INVENTION

The present invention is therefore aimed at remedying these problems by proposing a synchronization method and system that can operate even in the presence of one or more sources of interference and for which the transmission power does not need to be increased.

The present invention proposes a system for synchronizing a satellite pointing device using the transmission of a synchronization signal in a set of contiguous time intervals. The system comprises first means of selection of at least two time intervals belonging to the set, second means of selection of at least two distinct transmission frequencies, each transmission frequency being associated with one of the said selected time intervals. The system also comprises means for modulating the synchronization signal in the selected time intervals by using the transmission frequency respectively associated with the time interval and means for demodulating the synchronization signal received. Finally, the modulation means are integrated into a ground station and the demodulation means are integrated into a satellite terminal.

The method therefore allows the synchronization of a satellite pointing device by the transmission of a synchronization signal occupying a broader frequency spread band than that occupied by other synchronization methods. Indeed, this method makes it possible to use several different transmission frequencies successively. This makes it possible to render the reception of this synchronization signal resistant to interference. This resistance will depend on the number of transmission frequencies which are used for the transmission of the synchronization signal. Thus, if the band of the useful signal is b Hz and if the hop band is B Hz then the resistance (or processing gain) is said to be 10·log 10(B/b) dB. In the case of a modulated synchronization signal, having a spectral occupancy of 10 kHz and hopping in a band of 1 MHz, the processing gain is 10·log 10(1e6/1e4)=20 dB. Moreover, the method makes it possible to obtain a synchronization signal whose demodulation is difficult for a system not knowing the frequencies used to transmit this signal.

According to a technical characteristic, the first selection means are furthermore adapted for selecting at least two consecutive time intervals, the second selection means are adapted for selecting two distinct transmission frequencies, each transmission frequency being associated with one of the said consecutive time intervals. Moreover the modulation means are adapted for transmitting the synchronization signal in the consecutive time intervals and by using the two transmission frequencies associated with the consecutive time intervals.

This technical characteristic makes it possible to maximize the duration of transmission of the synchronization signal.

According to a technical characteristic the modulation means are adapted furthermore for the modulation of data in at least one time interval not selected by the first selection means and/or by using a frequency not selected by the second selection means.

This technical characteristic makes it possible to optimize the use of the resources used for the transmission of the synchronization signal and to use the time intervals not used for synchronization to dispatch data. This therefore makes it possible to increase the overall performance of the system using this synchronization method and the attainable bitrate. Moreover, since the synchronization signal is mixed with the other data, it is more difficult to detect by a system seeking to jam or to replay the synchronization signal.

Advantageously the modulation means are integrated into at least one satellite.

According to a technical characteristic the satellite terminal and/or the terrestrial station furthermore comprise means of coarse temporal synchronization.

The coarse synchronization is carried out on the basis of an estimation of:

the position of the satellite
This makes it possible to point the antenna towards the satellite with a precision of a few degrees. Indeed, it is necessary that the antenna receives a part of the energy of the signal of the satellite beacon.

The clock time and the transit time between the terminal and the satellite
Since the beacon hops in frequency at given tempo it is necessary to know precisely the time which served to determine the synchronization signal transmission frequency.

The coarse synchronization consists in detecting the energy of the synchronization signal. The fine synchronization consists in maximizing the energy peak corresponding to the optimal in terms of pointing position.

This technical characteristic allows the various elements of the system to have a coarse mutual synchronization. This makes it possible to detect the synchronization signal in a faster manner. Indeed, if the elements of the system are synchronized in a coarse manner, they can know the frequency which is used to dispatch the synchronization signal in a given time interval. If the elements are not synchronized in a coarse manner, they must make several assumptions about the possible frequency used for the transmission of the synchronization signal in a given time interval.

Advantageously the system comprises a device for determining the signal-to-noise ratio of at least one of the said time intervals, moreover the first selection means are adapted for selecting the time intervals whose signal-to-noise ratio exceeds a threshold.

Advantageously the modulation and transmission means 103 are adapted for generating the synchronization signal by transmitting bits generated by a pseudo-random generator, a seed of the said generator being determined on the basis of the clock time of the system.

Advantageously the modulation and transmission means are adapted for using an identical modulation for the modulation of the said synchronization signal and of the said data.

Advantageously the modulation and transmission means are adapted for the use of a spread spectrum modulation.

### BRIEF DESCRIPTION OF THE DRAWINGS

The invention will be better understood and other advantages will become apparent on reading the detailed description given by way of nonlimiting example with the aid of the following figures among which:

FIG. 1 presents the system according to a first aspect of the invention;

FIG. 2 presents the system according to a second aspect of the invention;

FIG. 3 presents the system according to a third aspect of the invention.

### DETAILED DESCRIPTION

Within the framework of a satellite system the process of synchronization between the pointing device for the satellite and for a satellite terminal or between the pointing device for a satellite terminal and for a ground station is a paramount process. Indeed the absence of synchronization, between the various elements of a satellite system, prevents the dispatching of data between the various satellite terminals or between a satellite terminal and a ground station.

The system therefore proposes the dispatching of a synchronization signal by using a time-varying transmission frequency. The use of a time-varying transmission frequency makes it possible to artificially increase the frequency spreading bandwidth used by the synchronization process. This makes it possible to render the synchronization method resistant to sources of interference. Thus, if the band of the useful signal is b Hz and if the hop band is B hz then the resistance (or processing gain) is said to be 10·log 10(B/b) dB. In the case of a modulated synchronization signal, having a spectral occupancy of 10 kHz and hopping in a band of 1 MHz, the processing gain is 10·log 10(1e6/1e4)=20 dB.

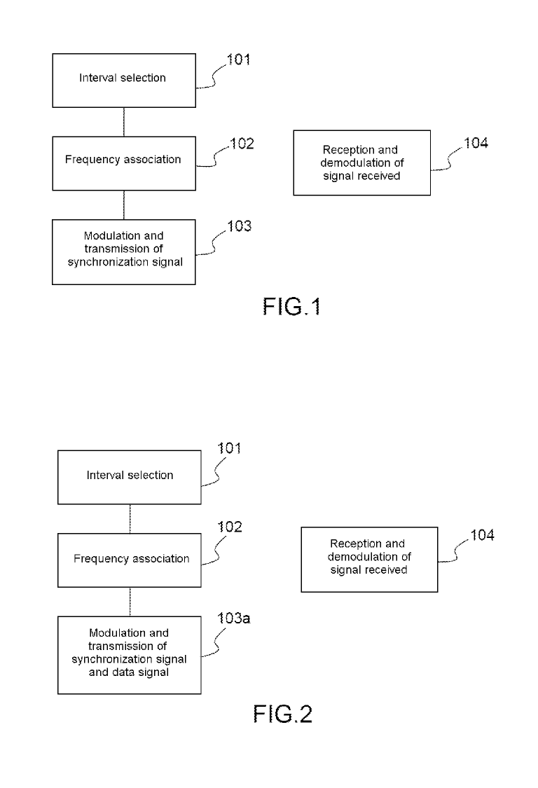

The satellite synchronization system such as presented in FIG. 1 uses a set of contiguous time intervals. This system comprises a first device 101 for selecting at least two time intervals belonging to the set. The system also comprises a second device 102 for selecting and associating two transmission frequencies with the two selected time intervals. Thereafter, the system comprises a device for modulation and transmission 103 of the synchronization signal in the selected time interval and by using the transmission frequency associated with the time interval. Finally, the system comprises a device for reception and demodulation 104 of the signal received.

The modulation device is generally integrated into a ground station but it can sometimes also be integrated into the satellite directly. The reception and demodulation device is for its part integrated into the satellite terminal.

It is also possible for the first selection device 101 to be adapted for selecting two consecutive time intervals. The second selection and association device 102 is then adapted for respectively associating two transmission frequencies with the two consecutive time intervals. Finally the modulation and transmission device 103 is adapted for transmitting the synchronization signal in the consecutive time intervals and by using the transmission frequency associated with these consecutive time intervals.

In the system such as presented in FIG. 2, the modulation device 103 a is adopted for the transmission of data in time intervals which are not used for the transmission of the synchronization signal. This technical characteristic makes it possible to limit the resources used for the transmission of the synchronization signal and therefore to increase the overall performance of the system using this synchronization method. Moreover, since the synchronization signal is mixed with the other data, it is almost undetectable and therefore the replay means are difficult to implement.

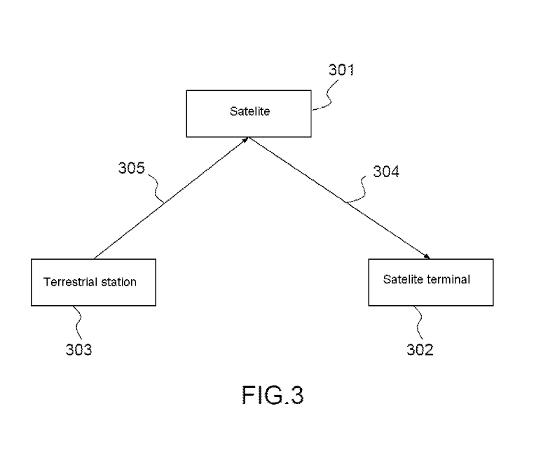

FIG. 3 presents the satellite system implementing the synchronization device. This system comprises a satellite 301, a satellite terminal 302 and a ground station 303. The generation of the synchronization signal is performed in two different ways. In the first, the satellite generates the synchronization signal and this signal is thereafter dispatched via the link 304 to the satellite terminal. In the second, the terrestrial station generates the synchronization signal. Thereafter, the terrestrial station dispatches this signal to the satellite via the link 305, and the latter reflects this signal towards the satellite terminal via the link 304.

Moreover, it is possible to add a device for coarse temporal synchronization into the terrestrial station and/or the satellite terminal. This device for coarse temporal synchronization is for example a satellite location system (for example the GPS (Global Positioning System) or Galileo system). Indeed, the signals dispatched by these satellite location systems provide an indication of the time and of the position that the various elements of the satellite system can use to estimate the clock time and the transit time between the terrestrial station and the terminal. The addition of this device makes it possible to reduce the time required for synchronization, this being particularly beneficial in respect of systems whose satellite terminal is mobile. These systems are also known by the name of OTM (On The Move) system.

In one embodiment the system furthermore comprises a device for determining the signal-to-noise ratio (known also by the acronym SNR) of the various time intervals.

The first selection device 101 is adapted for selecting the time intervals whose signal-to-noise ratio exceeds a threshold. This threshold is for example fixed at 2 dB.

This device for determining the SNR and the first selection device 101 thus modified are integrated into the terrestrial station.

Stated otherwise in the case of interference certain time intervals will have a poor SNR while others will have a good SNR. Thus it is sought to do the beacon tracking solely on the good time intervals. Thus it is sought to maximize the SNR peak (rather than the energy peak) by integrating over N time intervals the signal-to-noise ratio of the time intervals exceeding a value of for example 2 dB. The time intervals having an SNR below this threshold are not taken into account in the fine synchronization.

In one embodiment the modulation and transmission device 103 is adopted to generate the synchronization signal by transmitting bits generated by a pseudo-random generator. The seed of this generator is advantageously determined as a function of the clock time of the system.

Moreover the number of synchronization bits generated and modulated per time interval is determined so as to have a synchronization signal suited to the link budget of the most unfavoured terrestrial station of the network.

In one embodiment the modulation and transmission device 103 is adapted for transmitting more strongly while having a spectral power density of the synchronization signal complying with the standards (it is for example possible to cite the standards produced by the ITU or International Telecom Union). This makes it possible in particular to reach the very unfavoured terrestrial stations. Stated otherwise if it is desired to transmit a great deal of energy in this synchronization signal it is necessary to spread it frequency-wise and therefore modulate more synchronization bits per time interval. This frequency spreading can for example be carried out by using a modulation of CDMA (Code Division Multiple Access) type.

In one embodiment the modulation used to transmit the synchronization signal is the same as the modulation used to transmit the data signals. This makes it possible in particular to render the detection of this synchronization signal more complex by a system that is not entitled to receive the synchronization signal.

1. A system for synchronizing a satellite pointing device using the transmission of a satellite synchronization signal in a set of contiguous time intervals, comprising:
first means of selection of at least two time intervals belonging to the said set,
second means of selection of at least two distinct transmission frequencies, each transmission frequency being associated with one of the said selected time intervals,
means for modulating the said synchronization signal in the said selected time intervals by using the transmission frequency respectively associated with the said time interval, and
means for demodulating the synchronization signal received,
the modulation means being integrated into a ground station,
the demodulation means being integrated into a satellite terminal.

2. The synchronization system according to claim 1, in which the said first selection means are furthermore adapted for selecting at least two consecutive time intervals, the said second selection means are adapted for selecting two distinct transmission frequencies, each transmission frequency being associated with one of the said consecutive time intervals and the said modulation means are adapted for transmitting the said synchronization signal in the said consecutive time intervals and by using the two transmission frequencies associated with the said consecutive time intervals.

3. The synchronization system according to claim 1, in which the said modulation means are adapted furthermore for the modulation of data in at least one time interval not selected by the said first selection means and/or by using a frequency not selected by the said second selection means.

4. The synchronization system according to claim 2, in which the said modulation means are adapted furthermore for the modulation of data in at least one time interval not selected by the said first selection means and/or by using a frequency not selected by the said second selection means.

5. The synchronization system according to claim 1, in which the said modulation means are integrated into at least one satellite.

6. The synchronization system according to claim 2, in which the said modulation means are integrated into at least one satellite.

7. The synchronization system according to claim 3, in which the said modulation means are integrated into at least one satellite.

8. The synchronization system according to claim 4, in which the said modulation means are integrated into at least one satellite.

9. The synchronization system according to claim 1, in which the said satellite terminal and/or the said satellite and/or the said terrestrial station further comprise means of coarse temporal synchronization.

10. The synchronization system according to claim 2, in which the said satellite terminal and/or the said satellite and/or the said terrestrial station further comprise means of coarse temporal synchronization.

11. The synchronization system according to claim 3, in which the said satellite terminal and/or the said satellite and/or the said terrestrial station further comprise means of coarse temporal synchronization.

12. The synchronization system according to claim 4, in which the said satellite terminal and/or the said satellite and/or the said terrestrial station further comprise means of coarse temporal synchronization.

13. The synchronization system according to claim 5, in which the said satellite terminal and/or the said satellite and/or the said terrestrial station further comprise means of coarse temporal synchronization.

14. The synchronization system according to claim 6, in which the said satellite terminal and/or the said satellite and/or the said terrestrial station further comprise means of coarse temporal synchronization.

15. The synchronization system according to claim 7, in which the said satellite terminal and/or the said satellite and/or the said terrestrial station further comprise means of coarse temporal synchronization.

16. The synchronization system according to claim 8, in which the said satellite terminal and/or the said satellite and/or the said terrestrial station further comprise means of coarse temporal synchronization.

17. The synchronization system according to claim 1, comprising devices for determining the signal-to-noise ratio of at least one of the said time intervals, moreover the said first selection means are adapted for selecting the time intervals whose signal-to-noise ratio exceeds a threshold.

18. The synchronization system according to claim 1,
in which the said modulation and transmission means are adapted for generating the synchronization signal by transmitting bits generated by a pseudo-random generator, a seed of the said generator being determined on the basis of the clock time of the system.

19. The synchronization system according to claim 1,
in which the said modulation and transmission means are adapted for using an identical modulation for the modulation of the said synchronization signal and of the said data.

20. The synchronization system according to claim 1, in which the said modulation and transmission means are adapted for the use of a spread spectrum modulation.
